(19) United States
(12) Patent Application Publication
(10) Pub. No.: US 2025/0296561 A1
(43) Pub. Date: Sep. 25, 2025

(54) VEHICLE CONTROL DEVICE

(71) Applicant: HONDA MOTOR CO., LTD., Tokyo (JP)

(72) Inventor: Shigehiro HONDA, Tokyo (JP)

(73) Assignee: HONDA MOTOR CO., LTD., Tokyo (JP)

(21) Appl. No.: 19/059,283

(22) Filed: Feb. 21, 2025

(30) Foreign Application Priority Data
Mar. 25, 2024 (JP) 2024-048249

(51) Int. Cl. B60W 30/14

(52) U.S. Cl. CPC B60W 30/143; B60W 2552/05; B60W 2552/10; B60W 2552/30; B60W 2554/402; B60W 2555/20; B60W 2555/60; B60W 2720/106

(57) ABSTRACT

A vehicle control device for controlling a vehicle has circuitry configured to: recognize a surrounding situation of the vehicle; specify a lane position and/or a lane type of a first lane, in which the vehicle travels, on a road having the first lane; acquire information on a curvature of a curve when the curve is detected ahead of the vehicle in the first lane based on a recognition result; and control acceleration and deceleration of the vehicle based on a specification result and the acquired information on the curvature. The circuitry is configured to control acceleration and deceleration of the vehicle to achieve a target speed according to the lane position and/or the lane type of the first lane and the curvature of the curve.

### CROSS-REFERENCE TO RELATED APPLICATIONS

This application is based on and claims priority under 35 USC 119 from Japanese Patent Application No. 2024-048249 filed on Mar. 25, 2024, the contents of which are incorporated herein by reference.

### TECHNICAL FIELD

The present disclosure relates to a vehicle control device that controls a vehicle.

### BACKGROUND

In recent years, active efforts have been made to provide access to a sustainable transportation system in consideration of vulnerable traffic participants. As one of these efforts, research and development on driving assist techniques and automated driving techniques for vehicles such as automobiles have been made in order to further improve safety and convenience of traffic.

As an example of the driving assist technique, Japanese Patent Application Laid-Open Publication No. 2012-066758A below discloses a technique.

In the technique, it is determined whether a lane in which a host vehicle is traveling is a passing lane, and if it is determined that the host vehicle is traveling in a passing lane, a target acceleration is set such that responsiveness to the acceleration side of an own vehicle speed is relatively higher than that during traveling in a lane (cruising lane) other than the passing lane.

However, in the related art, there is room for improvement from the viewpoint of improving the convenience for a driver when a host vehicle is caused to travel following a traffic flow in a host lane.

An object of the present disclosure is to provide a vehicle control device capable of improving the convenience for a driver when a host vehicle is caused to travel following a traffic flow in a host lane. This further improves traffic safety and contributes to development of a sustainable transportation system.

### SUMMARY

An aspect of a vehicle control device for controlling a vehicle, the vehicle control device including circuitry configured to:
recognize a surrounding situation of the vehicle;
specify a lane position and/or a lane type of a first lane, in which the vehicle travels, on a road having the first lane;
acquire information on a curvature of a curve when the curve is detected ahead of the vehicle in the first lane based on a recognition result; and
control acceleration and deceleration of the vehicle based on a specification result and the acquired information on the curvature, in which
the circuitry is configured to control acceleration and deceleration of the vehicle to achieve a target speed according to the lane position and/or the lane type of the first lane and the curvature of the curve.

According to the present disclosure, it is possible to provide a vehicle control device capable of improving the convenience for a driver when a host vehicle is caused to travel following a traffic flow in a host lane.

### BRIEF DESCRIPTION OF DRAWINGS

Exemplary embodiments of the present disclosure will be described in detail based on the following figures, wherein:

FIG. 1 is a block diagram illustrating a schematic configuration of a vehicle 1 including a control device 30 according to an embodiment;

FIG. 2 is a diagram illustrating an example of control of the vehicle 1 performed by the control device 30;

FIG. 3 is a diagram illustrating another example of control of the vehicle 1 performed by the control device 30;

FIG. 4 illustrates an example of a target speed table Tb1 referred to by the control device 30;

FIG. 5 illustrates an example of a target speed correction table Tb2 referred to by the control device 30; and

FIG. 6 is a flowchart illustrating an example of processing executed by the control device 30.

### DESCRIPTION OF EMBODIMENTS

Hereinafter, an embodiment of a vehicle control device according to the present disclosure will be described with reference to the drawings. The following embodiment does not limit the present disclosure, and not all elements described in the following embodiment are essential to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Vehicle

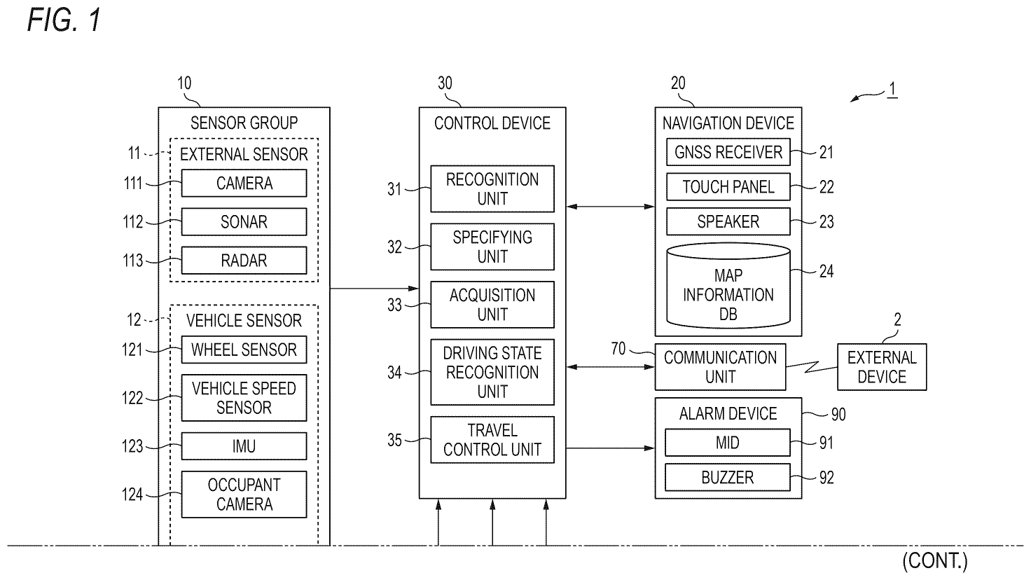

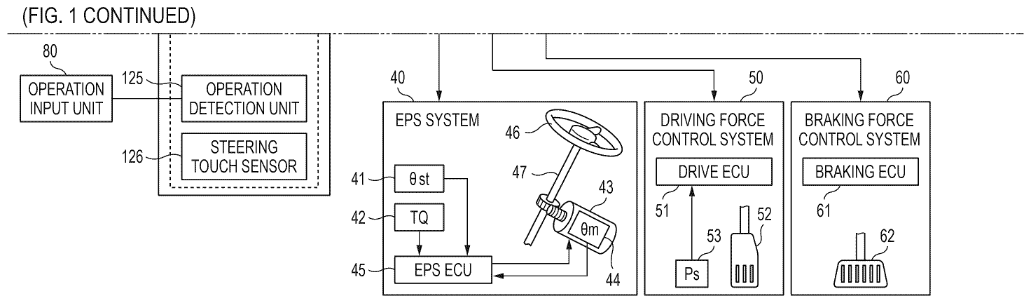

First, a vehicle according to the present embodiment will be described. A vehicle 1 according to the present embodiment illustrated in FIG. 1 (hereinafter, also referred to as a “host vehicle”) is an automobile including a drive source (not illustrated), and wheels (not illustrated) including drive wheels driven by power of the drive source and steered wheels that are steerable. As an example, the vehicle 1 may be a four-wheeled automobile having a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, a control device 30 that is an example of the vehicle control device of the present disclosure, an electric power steering (EPS) system 40, a driving force control system 50, a braking force control system 60, a communication unit 70, an operation input unit 80, and an alarm device 90.

The sensor group 10 includes an external sensor 11 that acquires information on a periphery of the vehicle 1 (hereinafter also referred to as “peripheral information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external sensor 11 includes, for example, a camera 111, a sonar 112, and a radar 113. The camera 111 is a digital camera that images the periphery of the vehicle 1 including the front of the vehicle 1 and outputs image data of an obtained peripheral image to the control device 30. As the camera 111, for example, a digital camera using an imaging element such as a charge-coupled device (CCD) or a complementary metal oxide semiconductor (CMOS) can be employed.

The sonar 112 emits sound waves to the periphery of the vehicle 1 (for example, the front, the rear, and lateral sides of the vehicle 1), and receives reflected sounds from an object present around the vehicle 1, thereby detecting a distance to the object, an azimuth of the object, and the like. The radar 113 emits radio waves to the periphery of the vehicle 1 including the front of the vehicle 1, and receives reflected waves from an object present around the vehicle 1, thereby detecting a distance to the object, an azimuth of the object, and the like. As the radar 113, for example, a millimeter wave radar can be employed.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present around the vehicle 1, thereby detecting a distance to the object, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects rotation angles of a left rear wheel and a right rear wheel. As the wheel sensor 121, for example, an angle sensor or a displacement sensor can be employed.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images a vehicle interior of the vehicle 1 and outputs image data of an obtained vehicle interior image to the control device 30. For example, the occupant camera 124 can be a so-called “driver monitor camera” that is provided so as to be able to image the head of an occupant from the front (in other words, image the face) who sits on a driver's seat of the vehicle 1 (hereinafter, also referred to as a “driver”). Similarly to the camera 111, a digital camera using an imaging element such as a CCD or a CMOS can be employed as the occupant camera 124. In the present embodiment, image data of a vehicle interior image obtained by the occupant camera 124 imaging the vehicle interior of the vehicle is information with which a direction of a line of sight of the driver can be specified.

The operation detection unit 125 detects an operation performed by using the operation input unit 80 that is provided to be operable by the driver. In the present embodiment, the operation input unit 80 can include, for example, an operation button (not illustrated) for receiving an operation to switch between on (in other words, operation) and off (in other words, non-operation) of ACC described later. In this case, the operation detection unit 125 can detect the operation of turning on/off the ACC.

The steering touch sensor 126 detects whether a steering 46 of the vehicle 1 is being appropriately gripped. For example, the steering touch sensor 126 is implemented by a capacitance sensor or the like. In this case, the capacitance sensor is provided at a portion touched by the driver when the steering 46 is appropriately gripped.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 and the like. The map information database 24 includes, for example, road network information that represents roads by combining nodes and links connecting the nodes.

The GNSS receiver 21 specifies a current position of the vehicle 1 (for example, a latitude and a longitude of a location where the vehicle 1 is located) based on a signals received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 is implemented by combining a display device such as a liquid crystal display or an organic light emitting diode (OLED) with a pointing device (for example, a touch pad). The speaker 23 is configured to output a sound to the occupant (for example, the driver) of the vehicle 1.

For example, the navigation device 20 searches for a route leading from the current position of the vehicle 1 to a destination, which is set by the driver using the touch panel 22, by referring to the map information database 24. Then, the navigation device 20 performs route guidance using the touch panel 22 and the speaker 23 based on a route obtained by the search. The navigation device 20 may cause the touch panel 22 to perform predetermined display in accordance with an instruction from the control device 30. Further, the navigation device 20 may output, to the control device 30, predetermined information such as information indicating a specified current position of the vehicle 1 or information indicating an operation received via the touch panel 22.

The control device 30 is a computer that includes, for example, a processor configured to perform various calculations, a storage unit having a non-transitory storage medium for storing various types of information, and an input and output unit configured to control input and output of data between an inside and an outside of the control device 30 (none of which is illustrated), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ that is a torque applied to the steering 46 of the vehicle 1, and outputs information indicating the detected steering torque TQ to the EPS ECU 45.

The EPS motor 43 applies a driving force or a reaction force to a steering column 47, which is coupled to the steering 46, in accordance with an instruction from the EPS ECU 45, thereby assisting the driver in operating the steering 46. The resolver 44 detects a rotation angle θm of the EPS motor 43 and outputs information indicating the detected rotation angle θm to the EPS ECU 45.

The EPS ECU 45 is a computer that includes, for example, a processor configured to perform various calculations, a storage unit having a non-transitory storage medium for storing various types of information, and an input and output unit configured to control input and output of data between an inside and an outside of the EPS ECU 45 (none of which is illustrated), and controls the EPS system 40 (for example, the EPS motor 43), and the EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. The steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor configured to perform various calculations, a storage unit having a non-transitory storage medium for storing various types of information, and an input and output unit configured to control input and output of data between an inside and an outside of the drive ECU 51 (none of which is illustrated), and controls the driving force control system 50, and the drive ECU 51 is implemented by one or more ECUs. For example, based on an operation on an accelerator pedal 52 provided in the vehicle 1, the drive ECU 51 controls the power output from the drive source of the vehicle 1. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor configured to perform various calculations, a storage unit having a non-transitory storage medium for storing various types of information, and an input and output unit configured to control input and output of data between an inside and an outside of the braking ECU 61 (none of which is illustrated), and controls the braking force control system 60, and the braking ECU 61 is implemented by one or more ECUs. For example, the braking ECU 61 controls a braking force of the vehicle 1 by controlling a brake device (not illustrated) provided in the vehicle 1 based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls the electric motor of the brake device such that a braking force corresponding to the operation on the brake pedal 62 is generated. The brake ECU 61 can also control the braking force control system 60 (for example, a brake device) according to an instruction from the control device 30.

The communication unit 70 is a communication interface that communicates with an external device 2 according to the control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be adopted for the communication between the vehicle 1 and the external device 2.

The alarm device 90 is a device that alarms the driver according to the control of the control device 30. The alarm device 90 includes, for example, a multi-information display (MID) 91 and a buzzer 92. The MID 91 is implemented by, for example, a display device such as a liquid crystal display or an OLED, is provided at a position (for example, in a meter panel of the vehicle 1) that can be visually recognized by the driver, and displays a predetermined alarm image in accordance with an instruction from the control device 30. The buzzer 92 is configured to output a predetermined alarm sound, and outputs the alarm sound in accordance with an instruction from the control device 30. One of the MID 91 and the buzzer 92 may be provided to serve both roles thereof, and one of the touch panel 22 and the speaker 23 may be provided to serve both roles thereof.

### Control Device

Next, the control device 30 will be described in more details. The control device 30 includes, for example, a recognition unit 31, a specifying unit 32, an acquisition unit 33, a driving state recognition unit 34, and a travel control unit 35, as functional units implemented by the processor executing a program stored in the storage unit of the control device 30.

The recognition unit 31 recognizes a surrounding situation of the vehicle 1. For example, the recognition unit 31 performs sensor fusion processing on detection results obtained by some or all of the camera 111, the sonar 112, and the radar 113 in the external sensor 11, and recognizes the surrounding situation of the vehicle 1 based on a processing result.

More specifically, the recognition unit 31 recognizes a position, a type, a speed, an acceleration, and the like of an object present around the vehicle 1. At this time, the recognition unit 31 recognizes the position of the object as a position on an absolute coordinate system in which a representative point (for example, the center of gravity and a center of a drive shaft) of the vehicle 1 is set as an origin. Accordingly, a relative position between the vehicle 1 and the object present around the vehicle 1 can be recognized. In the absolute coordinate system, the position of the object may be represented using a representative point such as a center of gravity or a corner of the object, or may be represented as a region.

Examples of objects that can be recognized by the recognition unit 31 include traffic participants such as other vehicles and pedestrians, traveling lane boundaries such as division lines, curbs and separation zones that define lanes, road structures such as road shoulders, guard rails and traffic cones, and road signs such as speed signs, construction signs and lane type signs. In addition to a so-called “general vehicle”, other vehicles that can be recognized by the recognition unit 31 include emergency vehicles such as a patrol car, a fire engine, and an ambulance, and the recognition unit 31 can distinguish an emergency vehicle from a general vehicle and recognize the emergency vehicle, for example. The recognition unit 31 can also recognize various road events such as a stop line, a traffic light, merging, branching, an interchange, a junction, and a tollgate of a toll road.

According to the recognition unit 31, it is possible to recognize a shape of a host lane that is a lane in which the vehicle 1 travels, a width of the host lane, a road structure present near the host lane, and the like. When another lane other than the host lane is present on a road having the host lane (in other words, a road on which the vehicle 1 travels), the recognition unit 31 can also recognize the other lane. The road having the host lane (that is, the road on which the vehicle 1 travels) is hereinafter also referred to as a “travel path”.

For example, the recognition unit 31 can recognize a default legal speed limit of a host lane based on a recognition result of a road sign corresponding to a travel path, or recognize a construction section present around the vehicle 1 in the travel path. Further, the recognition unit 31 can recognize an emergency vehicle present around the vehicle 1 in the travel path, or recognize a road event such as merging, branching, an interchange, a junction, a tollgate, or the like present around the vehicle 1 in the travel path.

The recognition unit 31 may recognize weather around the vehicle 1 and a road surface condition of a host lane (namely, a lane on which the host vehicle is traveling). For example, the recognition unit 31 can recognize weather (for example, whether it is raining) around the vehicle 1 or a road surface condition (for example, whether the road surface is wet) of the host lane based on a peripheral image captured by the camera 111.

When the control device 30 is configured to refer to high-precision map information (so-called “high-definition (HD) map”), the recognition unit 31 may recognize some or all of a shape and a width of a host lane, a road structure present near the host lane, another lane in a travel path, a road event present around the vehicle 1 in the travel path, and a default legal speed limit of the host lane based on the high-precision map information. In this case, the high-precision map information may be included in the map information database 24 or may be included in a database different from the map information database 24. Since the high-precision map information referred to as an HD map is well known, a detailed description thereof is omitted here.

The specifying unit 32 specifies a lane position and/or a lane type of a host lane, in which the vehicle 1 travels, on a road (that is, a travel path) having the host lane. For example, based on a positional relationship between a host lane and another lane of a travel path that are recognized by the recognition unit 31, the specifying unit 32 specifies, as the lane position of the host lane, a lane number of the host lane counting from one side or the other side in a width direction of the travel path (that is, a lane number). Regarding a lane type of the host lane, the specifying unit 32 may determine, for example, whether the host lane is a cruising lane or a passing lane based on a recognition result of a lane type sign recognized by the recognition unit 31. When the control device 30 is configured to refer to the high-precision map information, the specifying unit 32 may refer to the high-precision map information and specify the lane position and the lane type of the host lane in the travel path.

When a curve is detected ahead of the vehicle 1 in the host lane based on a recognition result of the recognition unit 31, the acquisition unit 33 acquires information on a curvature of the curve present ahead of the vehicle 1. For example, the acquisition unit 33 derives the curvature of the curve present ahead of the vehicle 1 based on a curvature of a traveling lane boundary of the host lane recognized from a peripheral image or the like captured by the camera 111, and acquires, as information on the curvature, information indicating the derived curvature or a radius of curvature that is an inverse of the curvature. When the control device 30 is configured to refer to the high-precision map information, the acquisition unit 33 may acquire, for example, the information on the curvature of the curve present ahead of the vehicle 1 based on a current position of the vehicle 1 specified by the navigation device 20 (for example, the GNSS receiver 21) and the high-precision map information.

The driving state recognition unit 34 recognizes a driving state of the driver of the vehicle 1. For example, based on a detection result of the steering touch sensor 126, the driving state recognition unit 34 recognizes, as a driving state of the driver, whether the steering 46 of the vehicle 1 is being gripped appropriately. In addition, the driving state recognition unit 34 may recognize, as a driving state of the driver, presence or absence of occurrence of looking aside of the driver by specifying a direction of a line of sight of the driver from a vehicle interior image obtained by the occupant camera 124.

The travel control unit 35 controls acceleration and deceleration of the vehicle 1 based on a specification result of the specifying unit 32 and information acquired by the acquisition unit 33. More specifically, when a curve is detected ahead of the vehicle 1 in the host lane, the travel control unit 35 controls acceleration and deceleration of the vehicle 1 to achieve a target speed according to a lane position and/or a lane type of the host lane specified by the specifying unit 32 and a curvature of the curve indicated by information acquired by the acquisition unit 33.

According to the control device 30 of the present embodiment having such a configuration, the vehicle 1 can travel in an automated manner at an appropriate travel speed set in consideration of not only the curvature of the curve present ahead of the vehicle 1 in the host lane but also the lane position and/or the lane type of the host lane. Accordingly, the vehicle 1 can travel following a traffic flow in the host lane without requiring an operation of the driver for causing the vehicle 1 to follow the traffic flow in the host lane, and the convenience for the driver when driving the vehicle 1 following the traffic flow in the host lane is improved. In addition, it is possible to improve traffic safety and contribute to development of a sustainable transportation system.

For example, for a road having a cruising lane and a passing lane, a traffic flow in the passing lane of the road is generally faster than a traffic flow in the cruising lane of the road. Therefore, when the lane type of the host lane is specified as a passing lane, the control device 30 (for example, the travel control unit 35) sets the target speed to be higher than when the lane type of the host lane is specified as a cruising lane. Accordingly, the vehicle 1 can travel in an automated manner at an appropriate travel speed set in consideration of a characteristic that the traffic flow in the passing lane is faster than the traffic flow in the cruising lane.

On a road where one or more cruising lanes are provided on one side in a width direction and one or more passing lanes are provided on the other side in the width direction, a lane closer to the passing lane side generally has a faster traffic flow. Therefore, the control device 30 (for example, the travel control unit 35) may set the target speed to be higher for the host lane as the host lane is closer to the other side (that is, the passing lane side). Accordingly, the vehicle 1 can travel in an automated manner at an appropriate travel speed set in consideration of a characteristic that the traffic flow is faster in a lane closer to the passing lane side.

The control device 30 (for example, the travel control unit 35) performs vehicle control based on the target speed during operation of predetermined driving assist control called adaptive cruise control (ACC), for example. The ACC is operated, for example, when an operation of turning on the ACC is detected by the operation detection unit 125. Since the ACC is well known, a detailed description thereof is omitted here.

### Example of Vehicle Control

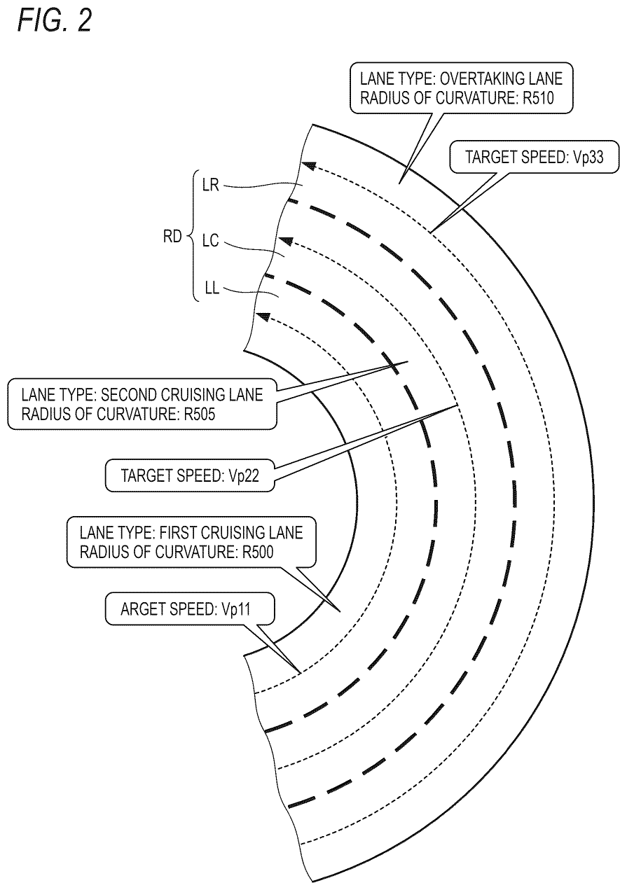

Next, an example of control of the vehicle 1 performed by the control device 30 (for example, the travel control unit 35) will be described with reference to FIGS. 2 to 5. Hereinafter, a radius of curvature is expressed by “R”, and for example, a radius of curvature of 500 [m] is expressed as “R500”, a radius of curvature of 505 [m] is expressed as “R505”, and a radius of curvature of 510 [m] is expressed as “R510”.

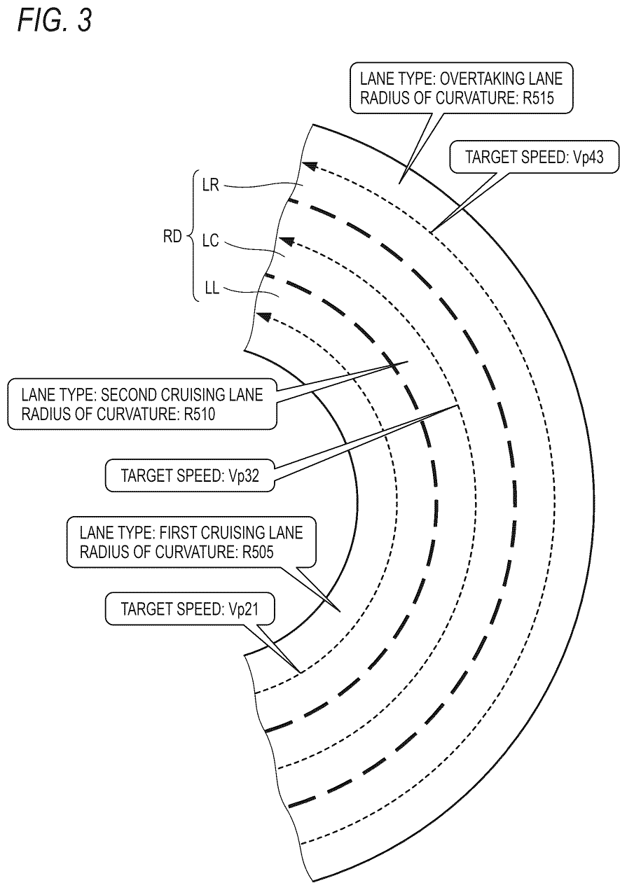

FIGS. 2 and 3 illustrate curve portions of a road RD including a left lane LL, a center lane LC and a right lane LR. The left lane LL has a lane type of “first cruising lane” and is located at the leftmost side (in other words, the one side in the width direction), the center lane LC has a lane type of “second cruising lane” and is located next to the left lane LL, and the right lane LR has a lane type of “passing lane” and is located at the rightmost side (in other words, the other side in the width direction).

In the curve portion illustrated in FIG. 2, a radius of curvature of the left lane LL is R500, a radius of curvature of the center lane LC is R505, and a radius of curvature of the right lane LR is R510. On the other hand, in the curve portion illustrated in FIG. 3, a radius of curvature of the left lane LL is R505, a radius of curvature of the center lane LC is R510, and a radius of curvature of the right lane LR is R515.

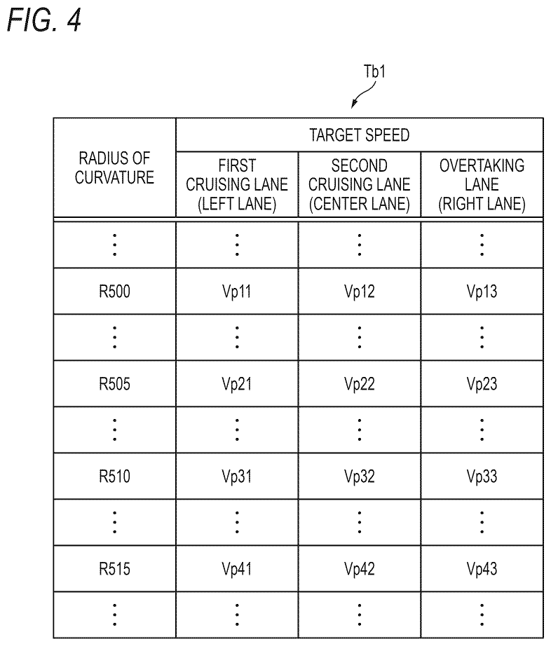

FIG. 4 illustrates an example of a target speed table Tb1 referred to by the control device 30. As illustrated in FIG. 4, the target speed table Tb1 is information defining a target speed of each lane corresponding to different radii of curvature. The target speed table Tb1 is stored in advance in the storage unit of the control device 30 by the manufacturer of the vehicle 1, for example.

In the target speed table Tb1 illustrated in FIG. 4, for example, when the radius of curvature is R500, a target speed of the first cruising lane (for example, the left lane located at the leftmost side) is Vp11, a target speed of the second cruising lane (for example, the center lane located next to the left lane) is Vp12 (where Vp12>Vp11), and a target speed of the passing lane (for example, the right lane located at the rightmost side) is Vp13 (where Vp13>

Vp12).

When the radius of curvature is R505, the target speed of the first cruising lane is Vp21 (where Vp21>Vp11), the target speed of the second cruising lane is Vp22 (where Vp22>Vp21 and Vp22>Vp12), and the target speed of the passing lane is Vp23 (where Vp23>Vp22 and Vp23>Vp13).

When the radius of curvature is R510, the target speed of the first cruising lane is Vp31 (where Vp31>Vp21), the target speed of the second cruising lane is Vp32 (where Vp32>Vp31 and Vp32>Vp22), and the target speed of the passing lane is Vp33 (where Vp33>Vp32 and Vp33>Vp23).

When the radius of curvature is R515, the target speed of the first cruising lane is Vp41 (where Vp41>Vp31), the target speed of the second cruising lane is Vp42 (where Vp42>Vp41 and Vp42>Vp32), and the target speed of the passing lane is Vp43 (where Vp43>Vp42 and Vp43>Vp33).

The control device 30 refers to the target speed table Tb1 and determines a target speed to be adopted when the vehicle 1 travels in the curve portion of the road RD.

Accordingly, in the case illustrated in FIG. 2, when the host lane is the left lane LL (that is, the first cruising lane), the control device 30 can set the target speed to Vp11. In the case illustrated in FIG. 2, when the host lane is the center lane LC (that is, the second cruising lane), the control device 30 can set the target speed to Vp22. In the case illustrated in FIG. 2, when the host lane is the right lane LR (that is, the passing lane), the control device 30 can set the target speed to Vp33.

On the other hand, in the case illustrated in FIG. 3, when the host lane is the left lane LL (that is, the first cruising lane), the control device 30 can set the target speed to Vp21. In the case illustrated in FIG. 3, when the host lane is the center lane LC (that is, the second cruising lane), the control device 30 can set the target speed to Vp32. In the case illustrated in FIG. 3, when the host lane is the right lane LR (that is, the passing lane), the control device 30 can set the target speed to Vp43.

That is, when the lane type and the lane position of the host lane are the same, the control device 30 can set the target speed to be higher as the radius of curvature increases (in other words, as the curvature decreases). When the curvature is the same, the control device 30 can set the target speed to be higher as the lane is closer to the passing lane side. For example, in a case where the radius of curvature is R505, the control device 30 can set the target speed to Vp21 when the host lane is the left lane LL (see the left lane LL in FIG. 3), and can set the target speed to Vp22 higher than Vp21 when the host lane is the center lane LC (see the center lane LC in FIG. 2).

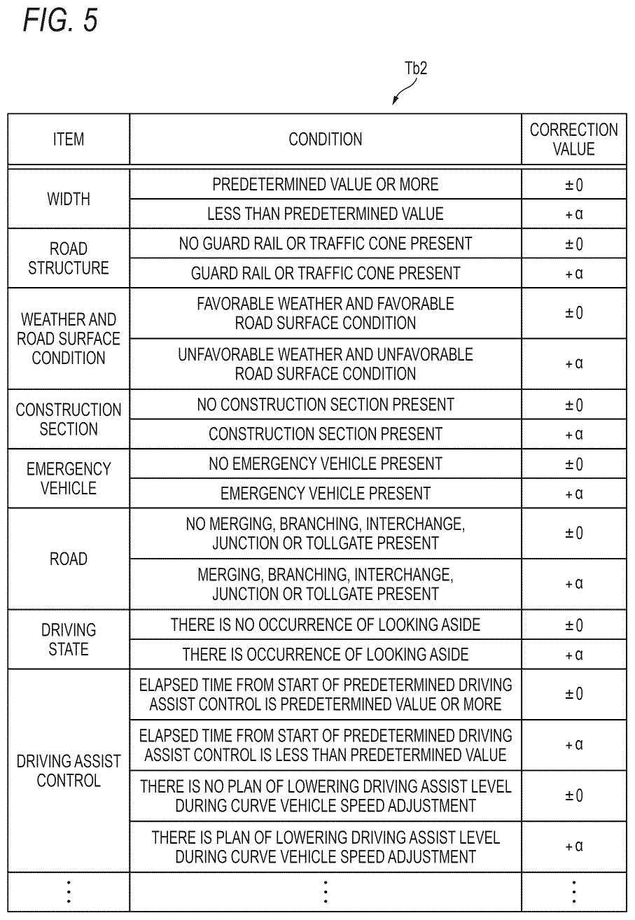

FIG. 5 illustrates a target speed correction table Tb2 referred to by the control device 30. The control device 30 may derive the target speed of the vehicle 1 based on the target speed table Tb1 described above, and correct the target speed based on the target speed correction table Tb2 in FIG. 5.

As an example, the control device 30 may correct, based on the target speed correction table Tb2, the target speed derived based on the target speed table Tb1 to a target speed according to a width of the host lane. For example, as illustrated in FIG. 5, when the width of the host lane is equal to or greater than a predetermined value (for example, 3 [m]), the control device 30 sets a correction value to ±0 and sets a speed derived based on the target speed table Tb1 as the target speed. On the other hand, when the width of the host lane is less than the predetermined value, the control device 30 sets the correction value to −α and sets, as the target speed, a speed obtained by subtracting α from the speed derived based on the target speed table Tb1.

That is, it is considered that, when the width of the host lane is equal to or greater than the predetermined value, the traffic flow in the host lane is faster than when the width of the host lane is less than the predetermined value. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and a width of the host lane. Accordingly, the vehicle 1 can travel in an automated manner at an appropriate travel speed set in consideration of not only the lane position and/or the lane type of the host lane and the curvature of the curve present ahead of the vehicle 1 but also the width of the host lane.

As another example, the control device 30 may correct, based on the target speed correction table Tb2, a target speed derived based on the target speed table Tb1 to a target speed according to a road structure present near the host lane. For example, as illustrated in FIG. 5, when no guard rail or traffic cone is present near the host lane (more specifically, near a traveling lane boundary of the host lane), the control device 30 sets a correction value to ±0 and sets a speed derived based on the target speed table Tb1 as the target speed. On the other hand, when a guard rail or a traffic cone is present near the host lane, the control device 30 sets the correction value to −α and sets, as the target speed, a speed obtained by subtracting α from the speed derived based on the target speed table Tb1.

That is, it is considered that, when a road structure such as a guard rail or a traffic cone that can collide with the vehicle 1 is present near the host lane, the traffic flow in the host lane is slower than when no road structure that can collide therewith is present. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and a road structure present near the host lane. Accordingly, the vehicle 1 can travel in an automated manner at an appropriate travel speed set in consideration of not only the lane position and/or the lane type of the host lane and the curvature of the curve present ahead of the vehicle 1 but also the road structure present near the host lane.

As another example, the control device 30 may correct, based on the target speed correction table Tb2, a target speed derived based on the target speed table Tb1 to a target speed according to weather around the vehicle 1 and/or a road surface condition of the host lane. For example, as illustrated in FIG. 5, when the weather around the vehicle 1 and the road surface condition of the host lane are favorable (for example, when it is not raining and the road surface is not wet), the control device 30 sets a correction value to ±0 and sets a speed derived based on the target speed table Tb1 as the target speed. On the other hand, when the weather around the vehicle 1 or the road surface condition of the host lane is unfavorable (for example, when it is raining and the road surface is wet), the control device 30 sets the correction value to α and sets, as the target speed, a speed obtained by subtracting α from the speed derived based on the target speed table Tb1.

That is, it is considered that, when the weather around the vehicle 1 is unfavorable or the road surface condition of the host lane is unfavorable, the traffic flow in the host lane is slower than when the weather around the vehicle 1 is favorable or the road surface condition of the host lane is favorable. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and weather around the vehicle 1 and/or a road surface condition of the host lane. Accordingly, the vehicle 1 can travel in an automated manner at an appropriate travel speed set in consideration of not only the lane position and/or the lane type of the host lane and the curvature of the curve present ahead of the vehicle 1 but also the weather around the vehicle 1 and/or the road surface condition of the host lane.

As another example, the control device 30 may correct, based on the target speed correction table Tb2, a target speed derived based on the target speed table Tb1 to a target speed according to presence or absence of a construction section around the vehicle 1. For example, as illustrated in FIG. 5, when no construction section is present around the vehicle 1 in a travel path, the control device 30 sets a correction value to ±0 and sets a speed derived based on the target speed table Tb1 as the target speed. On the other hand, when a construction section is present around the vehicle 1 in the travel path, the control device 30 sets the correction value to α and sets, as the target speed, a speed obtained by subtracting α from the speed derived based on the target speed table Tb1.

That is, it is considered that, when a construction section is present around the vehicle 1 in the travel path, the traffic flow in the host lane is slower than when no such construction section is present. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and presence or absence of a construction section around the vehicle 1 in a travel path. Accordingly, the vehicle 1 can travel in an automated manner at an appropriate travel speed set in consideration of not only the lane position and/or the lane type of the host lane and the curvature of the curve present ahead of the vehicle 1 in the host lane but also the presence or absence of a construction section around the vehicle 1 in the travel path having the host lane.

As another example, the control device 30 may correct, based on the target speed correction table Tb2, a target speed derived based on the target speed table Tb1 to a target speed according to presence or absence of an emergency vehicle around the vehicle 1. For example, as illustrated in FIG. 5, when no emergency vehicle is present around the vehicle 1 in a travel path, the control device 30 sets a correction value to ±0 and sets a speed derived based on the target speed table Tb1 as the target speed. On the other hand, when an emergency vehicle is present around the vehicle 1 in the travel path, the control device 30 sets the correction value to −α and sets, as the target speed, a speed obtained by subtracting α from the speed derived based on the target speed table Tb1.

That is, it is considered that, when an emergency vehicle is present around the vehicle 1 in the travel path, the traffic flow in the host lane is slower than when no such emergency vehicle is present. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and presence or absence of an emergency vehicle around the vehicle 1. Accordingly, the vehicle 1 can travel in an automated manner at an appropriate travel speed set in consideration of not only the lane position and/or the lane type of the host lane and the curvature of the curve present ahead of the vehicle 1 but also the presence or absence of an emergency vehicle around the vehicle 1.

As another example, the control device 30 may correct, based on the target speed correction table Tb2, a target speed derived based on the target speed table Tb1 to a target speed according to presence or absence of merging, branching, an interchange, a junction, or a tollgate around the vehicle 1. For example, as illustrated in FIG. 5, when no merging, branching, interchange, junction, or tollgate is present around the vehicle 1, the control device 30 sets a correction value to ±0 and sets a speed derived based on the target speed table Tb1 as the target speed. On the other hand, when merging, branching, an interchange, a junction, or a tollgate is present around the vehicle 1, the control device 30 sets the correction value to −α and sets, as the target speed, a speed obtained by subtracting α from the speed derived based on the target speed table Tb1.

That is, it is considered that, when merging, branching, an interchange, a junction, or a tollgate is present around the vehicle 1 in a travel path, the traffic flow in the host lane is slower than when no merging, branching, interchange, junction, or tollgate is present. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and presence or absence of merging, branching, an interchange, a junction, or a tollgate. Accordingly, the vehicle 1 can travel in an automated manner at an appropriate travel speed set in consideration of not only the lane position and/or the lane type of the host lane and the curvature of the curve present ahead of the vehicle 1 but also the presence or absence of merging, branching, an interchange, a junction, or a tollgate.

As another example, the control device 30 may correct, based on the target speed correction table Tb2, a target speed derived based on the target speed table Tb1 to a target speed according to a driving state of the driver of the vehicle 1. For example, as illustrated in FIG. 5, when the driver of the vehicle 1 does not look aside while driving, in other words, when a line of sight of the driver coincides with a traveling direction of the vehicle 1, the control device 30 sets a correction value to ±0 and sets a speed derived based on the target speed table Tb1 as the target speed. On the other hand, when the driver of the vehicle 1 looks aside while driving, in other words, when the line of sight of the driver does not coincide with the traveling direction of the vehicle 1, the control device 30 sets the correction value to−α a and sets, as the target speed, a speed obtained by subtracting α from the speed derived based on the target speed table Tb1.

That is, when a driving state of the driver is poor, such as the driver looking aside while driving, it is desirable to set a travel speed of the vehicle 1 to be lower than when the driving state of the driver of the vehicle 1 is good, from the viewpoint of safety. Therefore, the control device 30 (for example, the travel control unit 35) may control acceleration and deceleration of the vehicle 1 based on a specification result of the specifying unit 32, information acquired by the acquisition unit 33, and a recognition result of the driving state recognition unit 34 to achieve a target speed according to a lane position and/or a lane type of the host lane, a curvature of a curve present ahead of the vehicle 1, and a driving state of the driver. Accordingly, the vehicle 1 can travel in an automated manner at an appropriate travel speed set in consideration of not only the lane position and/or the lane type of the host lane and the curvature of the curve present ahead of the vehicle 1 but also the driving state of the driver.

Here, the target speed is varied depending on the presence or absence of occurrence of looking aside of the driver, and the disclosure is not limited thereto. For example, the target speed may be varied depending on whether the steering 46 is being gripped appropriately.

As another example, the control device 30 may correct, based on the target speed correction table Tb2, a target speed derived based on the target speed table Tb1 to a target speed based on an elapsed time from start of predetermined driving assist control such as the ACC. For example, as illustrated in FIG. 5, when the elapsed time from the start of the predetermined driving assist control is equal to or greater than a predetermined value, the control device 30 sets a correction value to ±0 and sets a speed derived based on the target speed table Tb1 as the target speed. On the other hand, when the elapsed time from the start of the predetermined driving assist control is less than the predetermined value, the control device 30 sets the correction value to −α and sets, as the target speed, a speed obtained by subtracting α from the speed derived based on the target speed table Tb1.

That is, since there is a possibility that the driver is not accustomed to driving assist control for a certain period after the start of the driving assist control, it is preferable to lower the travel speed of the vehicle 1 from the viewpoint of safety. Therefore, the control device 30 (for example, the travel control unit 35) may control acceleration and deceleration of the vehicle 1 based on a specification result of the specifying unit 32, information acquired by the acquisition unit 33, and an elapsed time from start of driving assist control to achieve a target speed according to a lane position and/or a lane type of the host lane, a curvature of a curve present ahead of the vehicle 1, and the elapsed time from the start of the driving assist control. Accordingly, the vehicle 1 can travel in an automated manner at an appropriate travel speed set in consideration of not only the lane position and/or the lane type of the host lane and the curvature of the curve present ahead of the vehicle 1 but also the elapsed time from the start of the driving assist control.

As another example, the control device 30 may correct, based on the target speed correction table Tb2, a target speed derived based on the target speed table Tb1 to a target speed based on a future vehicle control plan. For example, as illustrated in FIG. 5, when there is no plan to lower a driving assist level during curve vehicle speed adjustment described above (that is, during control of the acceleration and deceleration of the vehicle 1 based on a target speed based on the lane position of the host lane, the curvature of the curve, and the like), the control device 30 sets a correction value to ±0 and sets a speed derived based on the target speed table Tb1 as the target speed. On the other hand, when there is a plan to lower the driving assist level during the curve vehicle speed adjustment (for example, to transfer the driving operation to the driver), the control device 30 sets the correction value to −α and sets, as the target speed, a speed obtained by subtracting α from the speed derived based on the target speed table Tb1. Accordingly, the vehicle 1 can travel automatically at an appropriate travel speed set in consideration of not only the lane position and/or the lane type of the host lane and the curvature of the curve present ahead of the vehicle 1 but also the future vehicle control plan.

When a target speed that exceeds a default legal speed limit of the host lane is set, the vehicle 1 may travel at a speed exceeding the default legal speed limit of the host lane, and thus a target speed exceeding the default legal speed limit of the host lane is not preferable from the viewpoint of safety. Therefore, the control device 30 (for example, the travel control unit 35) may control acceleration and deceleration of the vehicle 1 based on a specification result of the specifying unit 32, information acquired by the acquisition unit 33, and a recognition result of the recognition unit 31 to achieve a target speed according to a lane position and/or a lane type of the host lane, a curvature of a curve present ahead of the vehicle 1, and a default legal speed limit of the host lane. Accordingly, the vehicle 1 can travel in an automated manner at an appropriate travel speed set in consideration of not only the lane position and/or the lane type of the host lane and the curvature of the curve present ahead of the vehicle 1 but also the default legal speed limit of the host lane.

### Processing Executed by Control Device

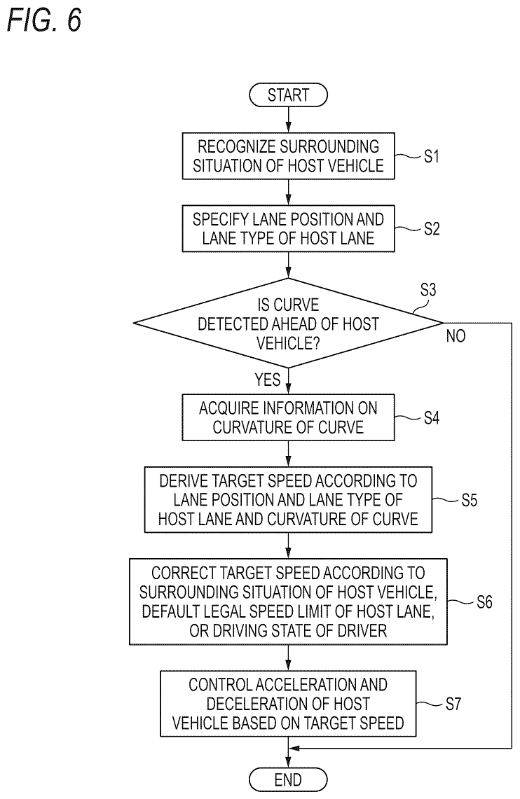

Next, an example of processing executed by the control device 30 will be described with reference to FIG. 6. For example, when an ignition power supply of the vehicle 1 is turned on, the control device 30 repeatedly executes a series of processing illustrated in FIG. 6 at a predetermined cycle.

As illustrated in FIG. 6, first, the control device 30 recognizes a surrounding situation of the vehicle 1 (step S1), and recognizes a lane position and a lane type of a host lane (step S2).

Next, the control device 30 determines whether a curve is detected ahead of the vehicle 1 in the host lane based on a recognition result according to the processing of step S1 (step S3). If no curve is not detected ahead of the vehicle 1 (step S3: NO), the control device 30 ends the series of processing illustrated in FIG. 6. On the other hand, if a curve is detected ahead of the vehicle 1 (step S3: YES), the control device 30 acquires information on a curvature of the curve (step S4).

Next, the control device 30 derives a target speed according to the lane position and the lane type of the host lane and the curvature of the curve based on, for example, the target speed table Tb1 illustrated in FIG. 4 (step S5).

Next, the control device 30 corrects the target speed derived from the processing of step S5 according to the surrounding situation of the vehicle 1, a default legal speed limit of the host lane, or a driving state of a driver based on, for example, the target speed correction table Tb2 illustrated in FIG. 5 (step S6). Then, the control device 30 controls acceleration and deceleration of the vehicle 1 based on the target speed corrected by the processing of step S6 (step S7), and ends the series of processing illustrated in FIG. 6.

As described above, according to the control device 30, the acceleration and deceleration of the vehicle 1 can be controlled in consideration of a curvature of a curve present ahead of the vehicle 1 in a host lane, a lane position and/or a lane type of the host lane, a surrounding situation of the vehicle 1, a default legal speed limit of the host lane, a driving state of a driver, and the like, and the vehicle 1 can travel in an automated manner at an appropriate travel speed.

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

For example, although the correction values for all the items in the target speed correction table Tb2 illustrated in FIG. 5 are fixed (±0 or −α) in the embodiment described above, the present disclosure is not limited thereto. For example, the correction value may be varied item by item. More specifically, the target speed may be subjected to −α when the width of the host lane is less than the predetermined value, and the target speed may be subjected to −β (where β≠α) when a guard rail or a traffic cone is present near the host lane.

In the present specification, at least the following matters are described. Although corresponding constituent elements and the like in the above embodiment are shown in parentheses, the present disclosure is not limited thereto.
(1) A vehicle control device (control device 30) for controlling a vehicle (vehicle 1), the vehicle control device including:
a recognition unit (recognition unit 31) configured to recognize a surrounding situation of the vehicle;
a specifying unit (specifying unit 32) configured to specify a lane position and/or a lane type of a host lane, in which the vehicle travels, on a road (road RD) having the host lane;
an acquisition unit (acquisition unit 33) configured to acquire information on a curvature of a curve when the curve is detected ahead of the vehicle in the host lane based on a recognition result of the recognition unit; and
a travel control unit (travel control unit 35) configured to control acceleration and deceleration of the vehicle based on a specification result of the specifying unit and information acquired by the acquisition unit, in which
the travel control unit controls acceleration and deceleration of the vehicle to achieve a target speed according to the lane position and/or the lane type of the host lane and the curvature of the curve.

Traffic flows in lanes on any road may vary depending on not only a curvature of a curve present in each lane but also a lane position and/or a lane type of each lane. According to (1), the acceleration and deceleration of the host vehicle is controlled to achieve the target speed according to the lane position and/or the lane type of the host lane in which the host vehicle travels and the curvature of the curve present ahead of the host vehicle in the host lane. Accordingly, the host vehicle can travel in an automated manner at an appropriate travel speed set in consideration of not only the curvature of the curve present ahead of the host vehicle in the host lane but also the lane position and/or the lane type of the host lane. Accordingly, the host vehicle can travel following a traffic flow in the host lane without requiring an operation of a driver for causing the host vehicle to follow the traffic flow in the host lane, and the convenience for the driver when driving the host vehicle following the traffic flow in the host lane is improved. In addition, it is possible to improve traffic safety and contribute to development of a sustainable transportation system.
(2) The vehicle control device according to (1), in which
the specifying unit specifies whether the host lane is a cruising lane (left lane LL, center lane LC) or a passing lane (right lane LR) as the lane type of the host lane, and when the lane type of the host lane is specified as a passing lane, the travel control unit sets the target speed to be higher than when the lane type of the host lane is specified as a cruising lane.

For a road having a cruising lane and a passing lane, a traffic flow in the passing lane of the road is generally faster than a traffic flow in the cruising lane of the road. According to (2), when the lane type of the host lane is specified as the passing lane, the target speed is set to be higher than when the lane type of the host lane is specified as the cruising lane. Accordingly, the host vehicle can travel in an automated manner at an appropriate travel speed set in consideration of a characteristic that the traffic flow in the passing lane is faster than the traffic flow in the cruising lane, and the convenience for the driver when driving the host vehicle following the traffic flow in the host lane is improved.
(3) The vehicle control device according to (1), in which
the road includes one or more cruising lanes on one side in a width direction and one or more passing lanes on the other side in the width direction,
the specifying unit specifies, as the lane position of the host lane, a lane number of the host lane counting from the one side or the other side, and
the travel control unit sets the target speed to be higher as the host lane is closer to the other side.

On a road where a plurality of lanes including a cruising lane and a passing lane are provided in a width direction, a lane closer to the passing lane side generally has a faster traffic flow. According to (3), the target speed is set to be higher as the host lane is closer to the other side (that is, the passing lane side). Accordingly, the host vehicle can travel in an automated manner at an appropriate travel speed set in consideration of a characteristic that the lane closer to the passing lane side has a faster traffic flow, and the convenience for the driver when driving the host vehicle following the traffic flow in the host lane is improved.
(4) The vehicle control device according to (2) or (3), in which
the recognition unit recognizes the surrounding situation including a width of the host lane, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and the width of the host lane.

For example, it is considered that, when a width of a host lane is equal to or greater than a predetermined value, a traffic flow in the host lane is faster than when the width of the host lane is less than the predetermined value. According to (4), the acceleration and deceleration of the host vehicle is controlled to achieve the target speed according to the lane position and/or the lane type of the host lane in which the host vehicle travels, the curvature of the curve present ahead of the host vehicle in the host lane, and the width of the host lane. Accordingly, the host vehicle can travel in an automated manner at an appropriate travel speed set in consideration of not only the lane position and/or the lane type of the host lane and the curvature of the curve present ahead of the host vehicle in the host lane but also the width of the host lane, and the convenience for the driver when driving the host vehicle following the traffic flow in the host lane is improved.
(5) The vehicle control device according to (2) or (3), in which
the recognition unit recognizes the surrounding situation including a road structure present near the host lane, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and the road structure present near the host lane.

For example, it is considered that, when a road structure such as a guard rail or a traffic cone that can collide with a vehicle is present near a host lane, a traffic flow in the host lane is slower than when no road structure that can collide therewith is present. According to (5), the acceleration and deceleration of the host vehicle is controlled to achieve the target speed according to the lane position and/or the lane type of the host lane in which the host vehicle travels, the curvature of the curve present ahead of the host vehicle in the host lane, and the road structure present near the host lane. Accordingly, the host vehicle can travel in an automated manner at an appropriate travel speed set in consideration of not only the lane position and/or the lane type of the host lane and the curvature of the curve present ahead of the host vehicle in the host lane but also the road structure present near the host lane, and the convenience for the driver when driving the host vehicle following the traffic flow in the host lane is improved.
(6) The vehicle control device according to (2) or (3), in which
the recognition unit recognizes the surrounding situation including weather around the vehicle and/or a road surface condition of the host lane, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and the weather around the vehicle and/or the road surface condition of the host lane.

For example, it is considered that, when weather around a host vehicle is unfavorable or a road surface condition of a host lane is unfavorable, a traffic flow in the host lane is slower than when the weather around the host vehicle is favorable or the road surface condition of the host lane is favorable. According to (6), the acceleration and deceleration of the host vehicle is controlled to achieve the target speed according to the lane position and/or the lane type of the host lane in which the host vehicle travels, the curvature of the curve present ahead of the host vehicle in the host lane, and the weather around the host vehicle and/or the road surface condition of the host lane. Accordingly, the host vehicle can travel in an automated manner at an appropriate travel speed set in consideration of not only the lane position and/or the lane type of the host lane and the curvature of the curve present ahead of the host vehicle in the host lane but also the weather around the host vehicle and/or the road surface condition of the host lane, and the convenience for the driver when driving the host vehicle following the traffic flow in the host lane is improved.
(7) The vehicle control device according to (2) or (3), in which
the recognition unit recognizes the surrounding situation including a construction section present around the vehicle on the road, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and presence or absence of the construction section.

It is considered that, when a construction section is present around the host vehicle on a road including a host lane, a traffic flow in the host lane is slower than when no such construction section is present. According to (7), the acceleration and deceleration of the host vehicle is controlled to achieve the target speed according to the lane position and/or the lane type of the host lane in which the host vehicle travels, the curvature of the curve present ahead of the host vehicle in the host lane, and the presence or absence of the construction section around the host vehicle on the road including the host lane. Accordingly, the host vehicle can travel in an automated manner at an appropriate travel speed set in consideration of not only the lane position and/or the lane type of the host lane and the curvature of the curve present ahead of the host vehicle in the host lane but also the presence or absence of the construction section around the host vehicle on the road including the host lane, and the convenience for the driver when driving the host vehicle following the traffic flow in the host lane is improved.
(8) The vehicle control device according to (2) or (3), in which
the recognition unit recognizes the surrounding situation including an emergency vehicle present around the vehicle on the road, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and presence or absence of the emergency vehicle.

For example, it is considered that, when an emergency vehicle is present around the host vehicle on a road including a host lane, a traffic flow in the host lane is slower than when no such emergency vehicle is present. According to (8), the acceleration and deceleration of the host vehicle is controlled to achieve the target speed according to the lane position and/or the lane type of the host lane in which the host vehicle travels, the curvature of the curve present ahead of the host vehicle in the host lane, and the presence or absence of the emergency vehicle around the host vehicle on the road including the host lane. Accordingly, the host vehicle can travel in an automated manner at an appropriate travel speed set in consideration of not only the lane position and/or the lane type of the host lane and the curvature of the curve present ahead of the host vehicle in the host lane but also the presence or absence of the emergency vehicle around the host vehicle on the road including the host lane, and the convenience for the driver when driving the host vehicle following the traffic flow in the host lane is improved.
(9) The vehicle control device according to (2) or (3), in which
the recognition unit recognizes the surrounding situation including merging, branching, an interchange, a junction, or a tollgate present around the vehicle on the road, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and presence or absence of the merging, the branching, the interchange, the junction, or the tollgate.

For example, it is considered that, when merging, branching, an interchange, a junction, or a tollgate is present around a host vehicle on a road including a host lane, a traffic flow in the host lane is slower than when no merging, branching, interchange, junction, or tollgate is present. According to (9), the acceleration and deceleration of the host vehicle is controlled to achieve the target speed according to the lane position and/or the lane type of the host lane in which the host vehicle travels, the curvature of the curve present ahead of the host vehicle in the host lane, and the presence or absence of the merging, the branching, the interchange, the junction, or the tollgate. Accordingly, the host vehicle can travel in an automated manner at an appropriate travel speed set in consideration of not only the lane position and/or the lane type of the host lane and the curvature of the curve present ahead of the host vehicle in the host lane but also the presence or absence of the merging, the branching, the interchange, the junction, or the tollgate around the host vehicle on the road including the host lane, and the convenience for the driver when driving the host vehicle following the traffic flow in the host lane is improved.
(10) The vehicle control device according to (2) or (3), in which
the recognition unit recognizes the surrounding situation including a default legal speed limit of the host lane, and
the travel control unit controls acceleration and deceleration of the vehicle based on a specification result of the specifying unit, information acquired by the acquisition unit, and a recognition result of the recognition unit to achieve the target speed according to the lane position and/or the lane type of the host lane, the curvature of the curve, and the default legal speed limit of the host lane.

According to (10), the acceleration and deceleration of the host vehicle is controlled to achieve the target speed according to the lane position and/or the lane type of the host lane, the curvature of the curve present ahead of the host vehicle in the host lane, and the default legal speed limit of the host lane. Accordingly, the host vehicle can travel in an automated manner at an appropriate travel speed set in consideration of not only the lane position and/or the lane type of the host lane and the curvature of the curve present ahead of the host vehicle in the host lane but also the default legal speed limit of the host lane, and the convenience for the driver when driving the host vehicle following the traffic flow in the host lane is improved.
(11) The vehicle control device according to (2) or (3), further including:
a driving state recognition unit (driving state recognition unit 34) configured to recognize a driving state of a driver of the vehicle, in which
the travel control unit controls acceleration and deceleration of the vehicle based on a specification result of the specifying unit, information acquired by the acquisition unit, and a recognition result of the driving state recognition unit to achieve the target speed according to the lane position and/or the lane type of the host lane, the curvature of the curve, and the driving state of the driver.

For example, when a driving state of a driver of a host vehicle is poor, such as the driver looking aside while driving, it is desirable to set a travel speed of the host vehicle to be lower than when the driving state of the driver of the host vehicle is good, from the viewpoint of safety. According to (11), the acceleration and deceleration of the host vehicle is controlled to achieve the target speed according to the lane position and/or the lane type of the host lane, the curvature of the curve present ahead of the host vehicle in the host lane and the driving state of the driver of the host vehicle. Accordingly, the host vehicle can travel in an automated manner at an appropriate travel speed set in consideration of not only the lane position and/or the lane type of the host lane and the curvature of the curve present ahead of the host vehicle in the host lane but also the driving state of the driver, and the safety of the host lane is improved.
(12) The vehicle control device according to (2) or (3), in which
the vehicle control device is capable of executing driving assist control for assisting a driver of the vehicle in driving, and
the travel control unit controls acceleration and deceleration of the vehicle based on a specification result of the specifying unit, information acquired by the acquisition unit, and an elapsed time from start of the driving assist control to achieve the target speed according to the lane position and/or the lane type of the host lane, the curvature of the curve, and the elapsed time.

For example, it is considered that, when driving assist control is started in a host vehicle, a certain period is required until the driver is accustomed to the driving assist control. Therefore, from the viewpoint of safety, it is desirable to set a travel speed of the host vehicle to be lower in the certain period after the start of the driving assist control than after the elapse of the period. According to (12), the acceleration and deceleration of the host vehicle is controlled to achieve the target speed according to the lane position and/or the lane type of the host lane, the curvature of the curve present ahead of the host vehicle in the host lane and the elapsed time from the start of the driving assist control in the host vehicle. Accordingly, the host vehicle can travel in an automated manner at an appropriate travel speed set in consideration of not only the lane position and/or the lane type of the host lane and the curvature of the curve present ahead of the host vehicle in the host lane but also the elapsed time from the start of the driving assist control, and the safety of the host lane is improved.

1. A vehicle control device for controlling a vehicle, the vehicle control device comprising circuitry configured to:
recognize a surrounding situation of the vehicle;
specify a lane position and/or a lane type of a first lane, in which the vehicle travels, on a road having the first lane;
acquire information on a curvature of a curve when the curve is detected ahead of the vehicle in the first lane based on a recognition result; and
control acceleration and deceleration of the vehicle based on a specification result and the acquired information on the curvature, wherein
the circuitry is configured to control acceleration and deceleration of the vehicle to achieve a target speed according to the lane position and/or the lane type of the first lane and the curvature of the curve.

2. The vehicle control device according to claim 1, wherein
the circuitry is configured to specify whether the first lane is a cruising lane or a passing lane as the lane type of the first lane, and
when the lane type of the first lane is specified as a passing lane, the circuitry sets the target speed to be higher than when the lane type of the first lane is specified as a cruising lane.

3. The vehicle control device according to claim 1, wherein
the road includes one or more cruising lanes on one side in a width direction and one or more passing lanes on the other side in the width direction,
the circuitry specifies, as the lane position of the first lane, a lane number of the first lane counting from the one side or the other side, and
the circuitry sets the target speed to be higher as the first lane is closer to the other side.

4. The vehicle control device according to claim 2, wherein
the circuitry recognizes the surrounding situation including a width of the first lane, and
the circuitry controls acceleration and deceleration of the vehicle based on the specification result, the acquired information on the curvature, and the recognition result to achieve the target speed according to the lane position and/or the lane type of the first lane, the curvature of the curve, and the width of the first lane.

5. The vehicle control device according to claim 2, wherein
the circuitry recognizes the surrounding situation including a road structure present near the first lane, and
the circuitry controls acceleration and deceleration of the vehicle based on the specification result, the acquired information, and the recognition result to achieve the target speed according to the lane position and/or the lane type of the first lane, the curvature of the curve, and the road structure present near the first lane.

6. The vehicle control device according to claim 2, wherein
the circuitry recognizes the surrounding situation including weather around the vehicle and/or a road surface condition of the first lane, and
the circuitry controls acceleration and deceleration of the vehicle based on the specification result, the acquired information, and the recognition result to achieve the target speed according to the lane position and/or the lane type of the first lane, the curvature of the curve, and the weather around the vehicle and/or the road surface condition of the first lane.

7. The vehicle control device according to claim 2, wherein
the circuitry recognizes the surrounding situation including a construction section present around the vehicle on the road, and
the circuitry controls acceleration and deceleration of the vehicle based on the specification result, the acquired information acquired, and the recognition result to achieve the target speed according to the lane position and/or the lane type of the first lane, the curvature of the curve, and presence or absence of the construction section.

8. The vehicle control device according to claim 2, wherein
the circuitry recognizes the surrounding situation including an emergency vehicle present around the vehicle on the road, and
the circuitry controls acceleration and deceleration of the vehicle based on the specification result, the acquired information acquired, and the recognition result to achieve the target speed according to the lane position and/or the lane type of the first lane, the curvature of the curve, and presence or absence of the emergency vehicle.

9. The vehicle control device according to claim 2, wherein
the circuitry recognizes the surrounding situation including merging, branching, an interchange, a junction, or a tollgate present around the vehicle on the road, and
the circuitry controls acceleration and deceleration of the vehicle based on the specification result, the acquired information, and the recognition result to achieve the target speed according to the lane position and/or the lane type of the first lane, the curvature of the curve, and presence or absence of the merging, the branching, the interchange, the junction, or the tollgate.

10. The vehicle control device according to claim 2, wherein
the circuitry recognizes the surrounding situation including a default legal speed limit of the first lane, and
the circuitry controls acceleration and deceleration of the vehicle based on the specification result, the acquired information acquired, and the recognition result to achieve the target speed according to the lane position and/or the lane type of the first lane, the curvature of the curve, and the default legal speed limit of the first lane.

11. The vehicle control device according to claim 2, wherein
the circuitry is further configured to recognize a driving state of a driver of the vehicle,
the circuitry is configured to control acceleration and deceleration of the vehicle based on the specification result, the acquired information, and a recognition result to achieve the target speed according to the lane position and/or the lane type of the first lane, the curvature of the curve, and the driving state of the driver.

12. The vehicle control device according to claim 2, wherein
the vehicle control device is capable of executing driving assist control for assisting a driver of the vehicle in driving, and
the travel control unit controls acceleration and deceleration of the vehicle based on a specification result of the specifying unit, information acquired by the acquisition unit, and an elapsed time from start of the driving assist control to achieve the target speed according to the lane position and/or the lane type of the first lane, the curvature of the curve, and the elapsed time.
